(19) United States
(12) Patent Application Publication
(10) Pub. No.: US 2007/0111884 A1
(43) Pub. Date: May 17, 2007

(54) Catalyst support, supported catalyst, and methods of making and using the same

(76) Inventors: Laiyuan Chen, Broken Arrow, OK (US); Jeffrey G. Weissman, Broken Arrow, OK (US)

Correspondence Address: Paul L. Marshall;Delphi Technologies, Inc., M/C 480-410-202, P.O. Box 5052, Troy, MI, 48007, US

(21) Appl. No.: 11/272,922

(22) Filed: Nov. 14, 2005

(51) Int. Cl. B01J 23/00

(52) U.S. Cl. 502/303; 502/325

(57) ABSTRACT

In one embodiment, the catalyst can comprise: a catalyst support and a rhodium catalyst disposed at the catalyst support. The catalyst support comprises a hexaluminate and alumina. The catalyst support was formed from a mixture comprising a greater than stoichiometric concentration of alumina and a material selected from the group consisting of a divalent cation component, a trivalent cation component, and combinations comprising at least one of the foregoing. In one embodiment, a method of making a fuel reforming catalyst can comprise: forming a mixture of a divalent cation component, a trivalent cation component, and a greater than stoichiometric concentration of alumina; heating the mixture to a temperature of greater than or equal to about 1,200° C. to form a catalyst support comprising a hexaluminate; and disposing a rhodium catalyst at the catalyst support.

### BACKGROUND

Partial oxidation fuel reforming reactions typically proceed at temperatures in excess of 1,000° C. During operation, temperatures exceeding 1,300° C. can sometimes be reached due to heat released during transient operations, system upsets, deliberately when high flow rates are required, or when operating in a mode where the heat lost via conduction, radiation, or convection, is less than the amount of heat generated by the reaction. Under these circumstances, typical catalysts and/or catalyst support materials can fail. The failure modes involve one or more of melting, recrystallization, sintering, collapse of pore structure, loss of surface area, etc. In all of these cases, changes to the catalyst and/or catalyst support structure result in a reduction of the amount of catalytic active sites available for the partial oxidation reaction. Thus, the effectiveness of the catalyst is reduced.

There is a need in the art for catalysts and catalyst supports with improved durability and thermal stability.

### SUMMARY

Disclosed herein are fuel reforming catalysts and methods for making fuel reforming catalysts. In one embodiment, the catalyst can comprise: a catalyst support and a rhodium catalyst disposed at the catalyst support. The catalyst support comprises a hexaluminate and alumina. The catalyst support was formed from a mixture comprising a greater than stoichiometric concentration of alumina and a material selected from the group consisting of a divalent cation component, a trivalent cation component, and combinations comprising at least one of the foregoing.

In another embodiment, the fuel reforming catalyst can comprise: a catalyst support and a rhodium catalyst disposed at the catalyst support. The catalyst support comprises a hexaluminate, and was formed from a mixture comprising a greater than stoichiometric concentration of alumina. The hexaluminate can comprise the formula LaMAl₁₁O₁₉, where M is selected from the group consisting of Ba, Ca, Cr, Co, Fe, Mg, Ni, Sr, Zn, and combinations comprising at least one of the foregoing.

In one embodiment, the method of making the catalyst can comprise: forming a mixture of a divalent cation component, a trivalent cation component, and a greater than stoichiometric concentration of alumina; heating the mixture to a temperature of greater than or equal to about 1,200° C. to form a catalyst support comprising a hexaluminate; and disposing a rhodium catalyst at the catalyst support.

The above-described and other features will be appreciated and understood from the following figures, detailed description, and appended claims.

### DRAWINGS

Refer now to the figures, which are exemplary embodiments, and wherein like elements are numbered alike.

FIGS. 1A and 1B are graphical representations of the catalysts tested in Example 2 comparing the relative hydrogen and relative methane of reformate gases resulting from various catalysts.

FIG. 2 is a graphical representation of X-ray diffraction patterns for the materials set forth in Example 2.

FIG. 3 is a graphical representation of X-ray diffraction patterns for the materials set forth in Example 2.

### DETAILED DESCRIPTION

It is noted that the terms “first,” “second,” and the like, herein do not denote any amount, order, or importance, but rather are used to distinguish one element from another, and the terms “a” and “an” herein do not denote a limitation of quantity, but rather denote the presence of at least one of the referenced item. Additionally, all ranges disclosed herein are inclusive and combinable (e.g., the ranges of “up to 25 wt. %, with 5 wt. % to 20 wt. % desired,” are inclusive of the endpoints and all intermediate values of the ranges of “5 wt. % to 25 wt. %,” etc.). The modifier “about” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants).

Disclosed herein are oxidation catalysts particularly fuel reforming catalysts, and methods of making the same. The catalysts comprise a hexaluminate, a greater than stoichiometric concentration of alumina (Al₂O₃), and a catalyst (e.g., rhodium iridium, and/or the like). In addition, the oxidation catalysts comprise improved hydrogen production relative to other oxidation catalysts, and can be used in devices that produce hydrogen (e.g., reformers, and the like). For example, the optimum performance of a device using reformate (e.g., a solid-oxide fuel cell, and the like) can be obtained if the hydrogen concentration in the reformate product is greater than or equal to about 20 volume percent (vol. %), which corresponds to about 83% of the maximum theoretical hydrogen concentration at typical air to fuel ratios and fuel compositions used in fuel reforming. The present oxidation catalysts can produce hydrogen concentrations of greater than or equal to about 20 vol. %, more particularly greater than or equal to about 22 vol. %.

Not to be bound by any theory, it is believed that oxidation catalysts that comprise a hexaluminate and alumina provide a synergistic improvement in the thermal stability of the catalyst support, allowing them to withstand temperatures greater than other oxidation catalysts. For example, hexaluminate materials are thermally stable at temperatures of about 1,000° C. Similarly, alumina is thermally stable at temperatures of about 1,000° C. However, catalyst supports comprising both hexaluminate and alumina unexpectedly exhibit thermal stability at temperatures of greater than or equal to about 1,200° C., more particularly greater than or equal to about 1,300° C., and more particularly still greater than about 1,370° C. Similarly, oxidation catalysts comprising both hexaluminate and alumina unexpectedly exhibit excellent performance and thermal stability at temperatures of greater than or equal to about 1,200° C., more particularly greater than or equal to about 1,300° C., and more particularly still greater than about 1,370° C., while maintaining the ability to produce levels of hydrogen acceptable for solid-oxide fuel cell applications (e.g., concentrations of greater than or equal to about 20 vol. %.).

Again, not to be bound by any theory, it is hypothesized that heat treatment of a mixture of a greater than stoichiometric concentration of alumina, a divalent cation component and a trivalent cation component, for a sufficient time and at a sufficient temperature can cause the formation of a hexaluminate in the catalyst support and/or oxidation catalyst. It is believed that providing a greater than stoichiometric concentration of alumina prevents the formation of other oxide compounds at the expense of the ternary hexaluminate composition. As used herein, a greater than stoichiometric concentration of alumina comprises a concentration greater than that which is required to form a stoichiometric hexaluminate compound when the alumina is combined with other metal oxides. It has been found that the hexaluminates can be formed under these conditions by heat treating at a temperature of about 1,200° C. for a period of about ten (10) hours, but it should be understood that the time and temperatures may be varied, provided that the resulting catalyst support and/or supported catalyst comprises hexaluminate and alumina. In addition, it should be noted that the heat treatment can be performed at different stages of the process of forming the catalyst support and/or the supported catalyst, provided that one or both are subjected to the foregoing heat treatment at about 1,200° C. for about ten (10) hours, or the equivalent thereof that results in the formation of the hexaluminate.

The oxidation catalyst can comprise a catalyst support comprising a greater than stoichiometric concentration of an alumina material and a hexaluminate (including compounds comprising hexaluminates substructures; e.g., M₁₃O₁₉, M₁₆O₂₂, M₁₆O₂₃ and/or M₁₉O₂₇, where M comprises a divalent cation component and/or a trivalent cation component). Examples of divalent cation components include barium (Ba⁺²), calcium (Ca⁺²), chromium (Cr⁺²), cobalt (Co⁺²), iron (Fe⁺²), magnesium (Mg⁺²), manganese (Mn⁺²), nickel (Ni⁺²), strontium (Sr⁺²), zinc (Zn⁺²), and so forth, as well as combinations comprises at least one of the foregoing. Examples of trivalent cation components include aluminum (Al⁺³), cerium (Ce⁺³), chromium (Cr⁺³), iron (Fe⁺³), lanthanum (La⁺³), manganese (Mn⁺³), yttrium (Y⁺³), and so forth, as well as combinations comprising at least one of the foregoing. Examples of hexaluminates include, but are not limited to, LaMgAl₁₁O₁₉, LaNiAl₁₁O₁₉, SrAl₁₂O₁₉, BaFe₁₂O₁₉, and so forth.

Formation of the catalyst support can comprise forming a mixture of a divalent cation component, a trivalent cation component, and a greater than stoichiometric concentration of an alumina material. The first and second components can be added to the mixture in elemental form (e.g., Ba⁺², Ca⁺², Cr⁺², Co⁺², Fe⁺², Mg⁺², Mn⁺², Ni⁺², Sr⁺², Zn⁺², Al⁺³, Ce⁺³, Cr⁺³, Fe⁺³, La⁺³, Mn⁺³, Y⁺³, and /or the like) and/or as a metal oxide (e.g., cerium oxide (Ce₂O₃), cobalt oxide (CoO), iron (ferrous) oxide (FeO), lanthanum oxide (La₂O₃), yttrium oxide (Y₂O₃), chromium oxide (Cr₂O₃), manganese oxide (Mn₂O₃), iron (ferric) oxide (Fe₂O₃) magnesium oxide (MgO), nickel oxide (NiO), zinc oxide (ZnO), and the like). The mixture can comprise about 1 wt. % to about 10 wt. %, more particularly about 3 wt. % to about 7 wt. %, and more particularly still about 5 wt. %, of the divalent cation component, based on the total weight of the mixture. The mixture can comprise about 2 wt. % to about 12 wt. %, more particularly about 3 wt. % to about 8 wt. %, and more particularly still about 4 wt. % of the trivalent cation component, based on the total weight of the mixture. The remainder of the mixture can comprise the alumina.

Possible alumina materials can comprise delta phase alumina (δ-alumina), gamma phase alumina (γ-alumina), alpha-phase alumina (α-alumina) and/or theta phase alumina (θ-alumina), and combinations comprising at least one of the foregoing. The alumina can comprise a surface area of about 0.1 square meter per gram (m²/g) to about 250 m²/g, more particularly, about 1 m²/g to about 200 m²/g, and still more particularly, about 5 m²/g to about 100 m²/g.

Formation of the stabilized alumina can be accomplished in various fashions, including stabilizing the alumina prior to the introduction of the catalyst, introducing the catalyst simultaneously with the stabilization of the alumina, and combinations comprising at least one of the foregoing. Examples of such methods include, but are not limited to, impregnation methods, co-precipitation methods, solid state reaction methods, fusion or melting of the component oxides, thermal decomposition, freeze-drying of aqueous solutions, or extraction of non-aqueous or aqueous solutions (such as super-critical drying), and/or the like.

For example, an aqueous solution can be formed comprising one or more of the foregoing alumina materials (e.g., in powder form) and a water-soluble salt of the first and second components. Examples of possible water-soluble salts include nitrates and/or acetate salts of the first and/or second component(s), and combinations comprising at least one of the foregoing. The resulting aqueous solution can be heat treated to impregnate the alumina with the component(s) and/or to form the hexaluminate materials. The duration of the heat treatment also can be varied e.g., the duration can range from about 1 to about 24 hours, which can depend on various factors, including the heating temperatures. In addition, the heating can be performed in stages, and the stages can have different durations. The aqueous solution can be heated at about 300° C. to about 1,300° C., more particularly about 550° C. to about 1,000° C., more particularly about 800° C. to about 1,200° C. For example, heat treating the aqueous solution at about 950° C. can vaporize the water and soluble salts, and stabilize the alumina. Alternatively, the heat treating the aqueous solution at 1,200° C. can vaporize the water and soluble salts, stabilize the alumina, and form the hexaluminates.

As stated above, the resulting catalyst support comprising an alumina stabilized with a hexaluminate is thermally stable at temperatures of greater than or equal to about 1,300° C., i.e. capable of withstanding temperatures of greater than or equal to about 1,300° C. without undergoing further changes in crystal phase, once stabilized at a temperature of about 1,200° C. for about ten (10) hours. The resulting catalyst support can comprise, for example, La—Mg—Al—O, La—Ni—Al—O, La—Ni—Mg—Al—O, and combinations comprising at least one of the foregoing. While some loss of surface area (i.e., densification) can occur during the heating process, it is believed that the final product can be stabilized against further densification, surface area loss and/or other physical changes due to presence of the foregoing hexaluminates (e.g., M₁₃O₁₉, M₁₆O₂₂, M₁₆O₂₃ and/or M₁₉O₂₇).

Alternatively, the metal oxide hexaluminates can be precipitated from the aqueous solution by, for example, adding a base to the aqueous solution. The co-precipitated hexaluminates then can be oxidized by heating for a period of time of about 6 to about 10 hours at a temperature of about 300° C. to about 1,000° C. After oxidizing, the metal oxides can be milled to a particle size of about 3 micrometers to about 8 micrometers.

The catalyst support can be used to support a catalyst, which can vary depending upon the type of device in which the catalyst will be employed. For example, in a fuel reformer, the catalyst can comprise rhodium, platinum, and/or nickel, other catalysts capable of fuel reforming, as well as oxides comprising at least one of the foregoing, alloys comprising at least one of the foregoing, and combinations comprising at least one of the foregoing. The supported catalyst can comprise a surface area of about 20 m²/g to about 60 m²/g. For example, a rhodium catalyst can be employed in a fuel reforming application. A manganese catalyst, on the other hand, is not effective at fuel reforming.

The catalytic material(s) can be combined with additional material(s) and disposed at the alumina (e.g., on and/or in the alumina), or the catalytic material and additional material(s) can be sequentially disposed on the alumina. The additional materials are dependent upon the type of catalyst. These materials can include alkali metals, alkaline earth metals, rare earth metals, Group VIII metals, and so forth, as well as, oxides comprising at least one of the foregoing, alloys comprising at least one of the foregoing, and combinations comprising at least one of the foregoing. Materials also can be added to improve usability of the catalyst support (i.e., during washcoating onto a substrate), to improve adhesion onto a catalyst support, and/or to act as a co-catalyst and/or activity enhancer for the catalyst. Possible materials can comprise barium (e.g., added as BaO, BaCO₃, BaSO₄, organometallic compounds of Ba, and/or the like), aluminum oxides, aluminum nitrate, and so forth, and combinations comprising at least one of the foregoing.

Forming the supported catalyst can be accomplished by various methods. For example, the catalyst can be disposed on the catalyst support by forming a mixture of the catalyst and the catalyst support, drying the mixture (actively or passively), and optionally calcining the dried mixture. More specifically, a slurry can be formed by combining the catalyst support (as a powder) with water, and optionally pH control agents (such as organic or inorganic acids and bases) and/or other components. The catalyst can be added to the slurry as a salt(s) (e.g., inorganic salt(s) and/or organic salt(s)). The slurry then can be applied to foregoing catalyst support, dried (actively or passively), and optionally heat-treated to fix the slurry onto the catalyst support e.g., at temperatures of about 90° C. to about 120° C. The fixed slurry can be dried (actively or passively) and heat-treated, e.g., at temperatures of about 300° C. to about 1,200° C., more specifically about 500° C. to about 700° C., to form the supported catalyst.

The supported catalyst can be disposed onto a substrate (e.g., monolithic substrate, foam, etc.) using various methods (e.g., washcoating the substrate with the slurry, extrusion of catalyst, support, and substrate, followed by heat-treating, and spray deposition (such as on a planar substrate)). Alternatively, or in addition, the foregoing slurry can be washcoated onto the substrate and then heat treated as described above, to adjust the surface area and crystalline nature of the catalyst support. Once the catalyst support has been heat treated, the catalyst can be disposed on the catalyst support. The catalyst, therefore, can be added after the slurry is fixed onto the substrate by additional washcoat steps and/or by exposing the washcoated substrate to a liquid containing the catalytic metal.

The substrate can comprise any material designed for use in the desired environment, e.g., a reformer for a solid oxide fuel cell. Possible substrate materials include, but are not limited to, cordierite, silicon carbide, metal, metal oxides (e.g., alumina, and the like), mixed metal oxides (e.g., zirconia toughened alumina (ZTA), zirconia-alumina, yttria stabilized zirconia (YSZ), yttria-stabilized alumina, mullite, zirconia-stabilized mullite), glasses, and so forth, and mixtures comprising at least one of the foregoing. The substrate materials can be in the form of packing material, extrudates, foils, preforms, mat, fibrous material, monoliths (e.g., a honeycomb structure, and the like), other porous structures (e.g., porous glasses, sponges), foams, molecular sieves, and so forth (depending upon the particular device), and combinations comprising at least one of the foregoing materials and forms, e.g., metallic foils, open pore alumina sponges, and porous ultra-low expansion glasses. Furthermore, these substrates can be coated with oxides and/or hexaluminates, such as stainless steel foil coated with a hexaluminate scale. The washcoat (catalyst and support) can be disposed onto the substrate as a single layer, in multiple uniform or non-uniform layers having different washcoat formulations, as uniform coatings, with gradients or different or single formulations, in zones or regions, according to the needs to the catalytic application.

Although the substrate can have any size or geometry, the size and geometry can be selected to optimize the geometric area in the given fuel processing control device design parameters, as well as the surface area. For example, the substrate can comprise a honeycomb geometry, with the channels of the combs comprising a variety of shapes such as round or multi-sided (e.g., square, triangular, pentagonal, hexagonal, heptagonal, octagonal and/or the like).

Catalyst loadings can be expressed in terms of concentration of catalyst in the supported catalyst, and concentration of supported catalyst on a substrate, if employed. For example, in some embodiments, concentrations of catalyst in the supported catalyst can comprise about 0.01 wt. % to about 10 wt. %, more specifically about 1 wt. % to about 3 wt. %, based upon the total combined dry weight of the catalyst and the catalyst support. Loadings on a substrate can, in some applications, comprise about 10 grams per cubic foot of substrate (g/ft³) to about 300 g/ft³, or, more specifically, about 25 g/ft³ to about 200 g/ft³, or, even more specifically, about 50 g/ft³ to about 150 g/ft³, based on the volume of the substrate. The supported catalyst can be disposed on and/or throughout (collectively referred to herein as “on”) a substrate, e.g., wash coated, imbibed, impregnated, physisorbed, chemisorbed, precipitated, or otherwise applied to the substrate.

Once the supported catalyst is disposed on the substrate, the substrate can be disposed in a housing to form, for example, a reformer. The housing can have any design and comprise any material suitable for the application. Possible materials for the housing can comprise ceramics, metals, alloys, and the like, such as aluminum oxide, ferritic stainless steels (including stainless steels such as, e.g., the 400 -Series such as SS-409, SS-439, and SS-441), and other alloys (such as those containing nickel (Ni), chromium (Cr), aluminum (Al), yttrium (Y), and the like, e.g., to permit increased stability and/or corrosion resistance at operating temperatures or under oxidizing or reducing atmospheres).

Also similar materials as the housing, end cone(s), end plate(s), exhaust manifold cover(s), and the like, can be concentrically fitted about the one or both ends and secured to the housing to provide a gas tight seal. These components can be formed separately (e.g., molded or the like), or can be formed integrally with the housing using a methods such as, e.g., a spin forming, or the like.

Disposed between the housing and the substrate can be a retention material. The retention material, which may be in the form of a mat, particulates, or the like, may be an intumescent material (e.g., a material that comprises vermiculite component, i.e., a component that expands upon the application of heat), a non-intumescent material, or a combination thereof. These materials may comprise ceramic materials (e.g., ceramic fibers) and other materials such as organic and inorganic binders and the like, or combinations comprising at least one of the foregoing.

During use, the housing can be disposed in an exhaust system (e.g., of a compression ignition engine). Exhaust from the engine flows into the housing and contacts the catalyst. In the housing, the exhaust can be mixed with additional reactants, for example, fuel, air, water and/or fuel-cell anode tail gas.

The following examples are intended to be illustrative, not limiting.

### WORKING EXAMPLES

### Example 1

Comparison of the performance of rhodium supported catalysts with different catalyst support compositions. Four different processes (A-D) were used to form the oxidation catalysts, as shown below, after which solution of the supported rhodium catalysts was prepared and applied to a ceramic ZTA foam substrate with a pore size of 20 pores per inch (PPI).

Method A

An aqueous mixture of magnesium nitrate and a commercially available gamma alumina powder containing lanthanum was prepared. The mixture was heat treated at a temperature of about 950° C. in air to vaporize the water and the nitrates and to stabilize the alumina. The result of the heat treatment was a catalyst support comprising a powdered mixture of oxides.

An aqueous slurry of the catalyst support and rhodium nitrate was prepared. The slurry was applied (i.e., washcoated) onto a monolithic substrate, which was then heat treated in air at a temperature of about 538° C. for a period of about 1 hour.

Thereafter, the finished catalysts were placed in static air at a temperature of about 1,200° C. for a period of about 10 hours in order to form a stabilized mixture of hexaluminate and alumina.

Method B

An aqueous mixture of lanthanum nitrate, magnesium nitrate, and aluminum nitrate was prepared. Thereafter, the same steps used in Method A were used, beginning with the heat treatment at a temperature of about 950° C.

Method C

In Method C, the rhodium catalyst was added in the initial mixture. Thus, an aqueous mixture of lanthanum nitrate, magnesium nitrate, aluminum nitrate and rhodium nitrate was prepared. The mixture was heat treated at a temperature of about 1,200° C. in air to vaporize the water and the nitrates and to stabilize the alumina, thereby forming an oxidation catalyst comprising a powdered mixture of oxides and the rhodium catalyst.

An aqueous slurry of the oxidation catalyst was prepared. The slurry was applied (i.e., washcoated) onto a monolithic substrate, which was then heat treated in air at a temperature of about 538° C. for a period of about 1 hour.

Method D

In Method D, the rhodium catalyst was also added in the initial mixture. Thus, an aqueous mixture of lanthanum nitrate, magnesium nitrate, aluminum nitrate and rhodium nitrate was prepared. The mixture was heat treated at a temperature of about 538° C. in air to vaporize the water

An aqueous slurry of the oxidation catalyst was prepared. The slurry was applied (i.e., washcoated) onto a monolithic substrate, which was then heat treated in air at a temperature of about 538° C. for a period of about 1 hour.

Thereafter, the finished catalysts were placed in static air at a temperature of about 1,200° C. for a period of about 10 hours in order to form a stabilized mixture of hexaluminate and alumina.

The effectiveness of the oxidation catalysts prepared above for the partial oxidation of gasoline was tested using an oxygen to carbon molar ratio of about 1.05. The finished catalysts were loaded in stainless steel tubular reactors, operated in down-flow mode, and secured by alumina wrap material. Fuel and airflow rates were selected to provide a space velocity of about 45,000/hour, calculated at 0° C. and at a pressure of 1 atmosphere, and considering all fuel molecules to be in the gas phase. A fuel flow rate of 2.3 g/minute was required to reach this space velocity. The fuel was gasoline containing about 30 parts per million, by weight, of sulfur, 13.7 wt. % hydrogen, 27 vol. % aromatics, and about 11 wt. % methyl-t-butyl ether. Thermal-conductivity (TCD) and flame-ionization detectors (FID) fitted on gas chromatographs were used to analyze the reformate. Prior to gas analysis, product water was collected and measured. The results show the effectiveness of the supported catalysts for the partial oxidation of gasoline. Although only gasoline was tested, it is expected that the present catalyst supports will work equally well for diesel fuel with a variety of sulfur or aromatic contents, methane, natural gas, propane, kerosene, aviation fuel, methanol, ethanol, etc. The test results are shown below in Table 1.

To further test the thermal stability of the catalysts, another a test was performed, in which the air-fuel ratio was adjusted by increasing the air flow rate, to cause the catalyst temperatures to exceed 1,300° C. for about 30 minutes (i.e., 1,300° C. heat treatment in Table 1). Performance was evaluated after returning to the prior air fuel ratio (i.e., oxygen to carbon molar ratio of about 1.05). The test results are shown below in Table 1.

TABLE 1

| Method of | | | | |
|---|---|---|---|---|
| forming | After 1,200° C. | | After 1,300° C. | |
| oxidation | heat treatment | | heat treatment | |
| catalyst | H₂ (vol. %) | % max. H₂ | H₂ (vol. %) | % max. H₂ |
| 1A | 22.1 | 92 | 21.5 | 90 |
| 1B | 22.1 | 92 | 22.2 | 92 |
| 1C | 21.0 | 87 | 20.5 | 85 |
| 1D | 21.6 | 90 | 21.1 | 88 |

As noted above, compositions that produce concentrations of greater than or equal to about 20 vol. % hydrogen in the product gas are considered acceptable for use in solid-oxide fuel cells, whereas compositions that produce a concentration of less than 20 vol. % hydrogen are considered unacceptable for such applications. As shown below in Table 1, all of the compositions produced greater than 20 vol. % hydrogen in the product gas, and were therefore considered acceptable for use in solid-oxide fuel cells. In addition, Table 1 shows that even after the 1,300° C. heat treatment, the catalysts remained thermally stable, in contrast to other oxidation catalysts, which do not retain performance after being subjected to such high temperatures (i.e., 1,300° C.).

### Example 2

Comparison of catalyst support compositions. A rhodium catalyst was supported on three different catalyst supports to form the following supported catalysts: Rh/γ-Al₂O₃; Rh/MgO—Al₂O₃; and Rh/La₂O₃—MgO—Al₂O₃. The γ-Al₂O₃ catalyst support was obtained commercially and used as received. The MgO—Al₂O₃ catalyst support was formed by adding an aqueous solution of magnesium nitrate to the same γ-Al₂O₃. The La₂O₃—MgO—Al₂O₃ was catalyst support formed by adding lanthanum nitrate to the MgO-γ-Al₂O₃. Each step was followed by a heat treatment in air at about 950° C. for about one hour. Rh was added to each of the foregoing by addition of Rh nitrate, followed by heat treatment in air at about 538° C. for about 1 hour.

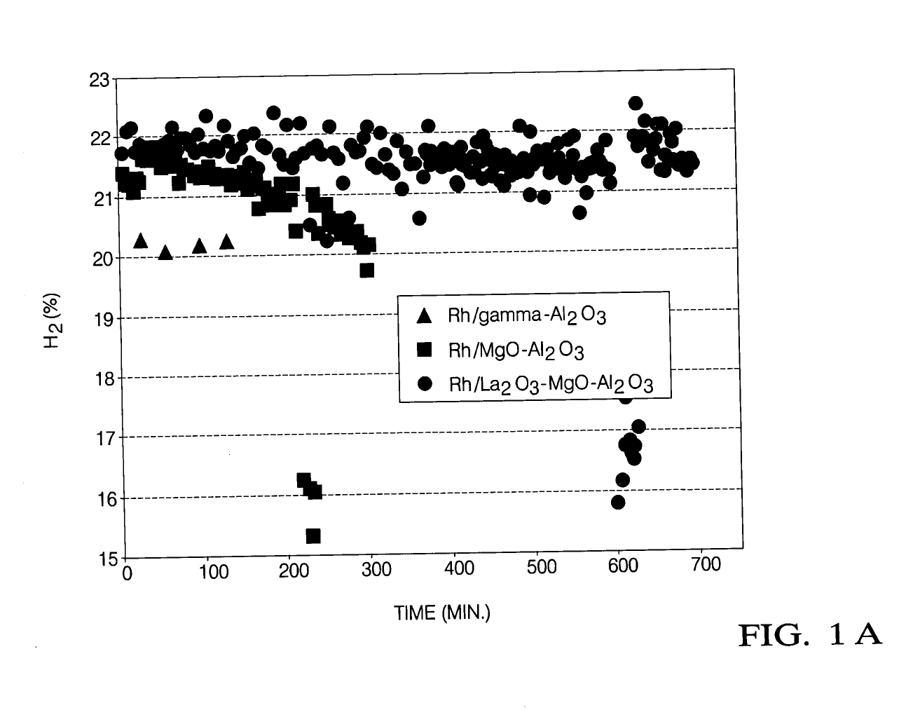

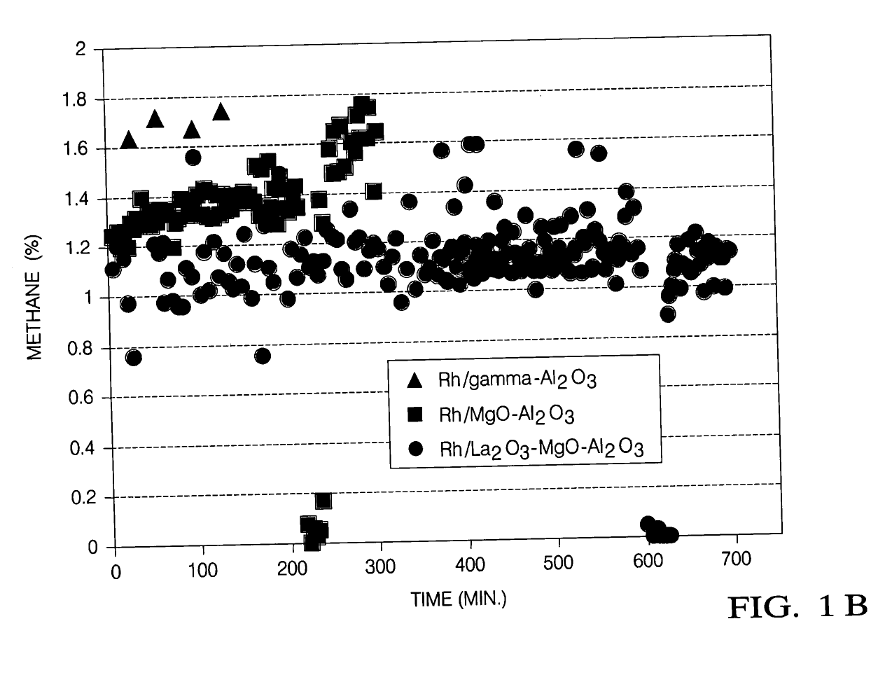

FIG. 1A is a graphical representation of the relative hydrogen concentration of reformate gases resulting from the foregoing supported catalysts when used for partial oxidation of gasoline, according to the same general reaction procedures as in Example 1. As shown; the selectivity to hydrogen of the Rh/γ—Al₂O₃ composition was low. The hydrogen selectivity of the Rh/MgO-Al₂O₃ decreased with reaction time, and dropped quickly after heat treatment at about 1,300° C. for about ½ hour, then evaluating performance after returning to lower temperature. In contrast, the Rh/La₂O₃—MgO—Al₂O₃ showed the same hydrogen selectivity before and after thermal treatment at 1,300° C., and had stable performance for the duration of the test.

FIG. 1B is a graphical representation of the relative methane concentration of the reformate gases resulting from the supported catalysts shown in FIG. 1A. Because methane is undesirable in fuel cell applications, its concentration can be used as an indicator of catalyst performance and stability. The Rh/La₂O₃—MgO—Al₂O₃ composition showed the highest hydrogen selectivity and the best stability of the three different of catalyst supports, making it the most suitable for use under reforming conditions.

### Example 3

The Rh/MgO—Al₂O₃ and Rh/La₂O₃—MgO—Al₂O₃ supported catalysts from Example 2 were heat treated in air for a period of about ten (10) hours at three different temperatures: about 950° C., about 1,050° C. and about 1,200° C.

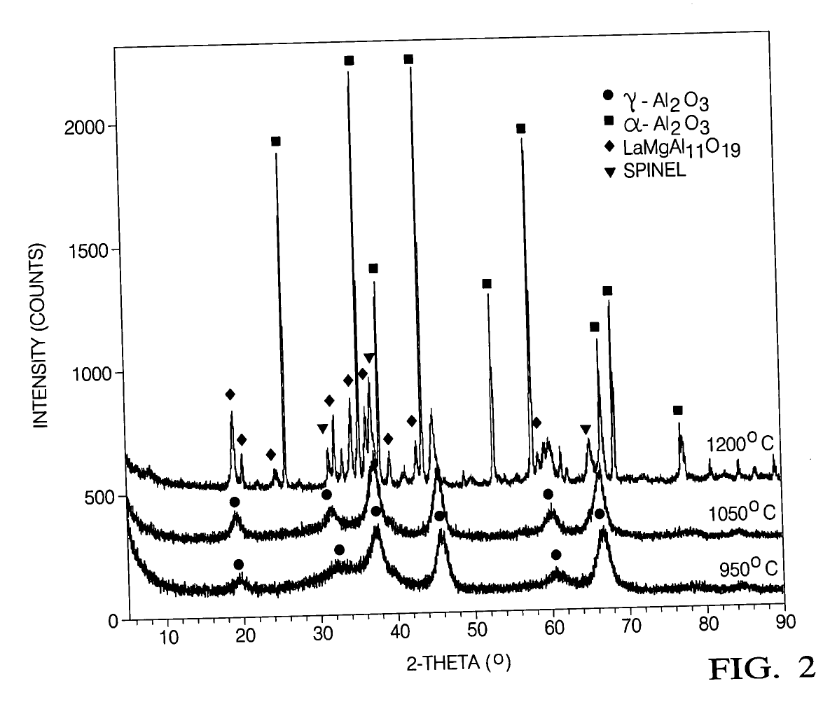

As shown in FIG. 2, X-ray diffraction (XRD) confirmed that the crystal structure of the Rh/La₂O₃—MgO—Al₂O₃ had not changed after heat treatment at 950° C., i.e. it was free of a spinel phase, free of Rh oxide, and free of alpha alumina, and exhibited broad diffraction intensities due to the presence of gamma alumina. This confirms that the gamma alumina had not changed phases to alpha alumina, and that thermal stability of the catalyst support was not due to the presence of spinel.

After heat treatment at about 1,200° C. for about 10 hours, a change in the crystal structure of the catalyst was detected by XRD. Specifically, the gamma-alumina phase was no longer detected, and an alpha-alumina phase, a rhodium oxide phase, and a minor spinel phase (MgAl₂O₄) was detected. In addition, a significant amount of LaMgAl₁₁O₁₉ was detected, which has a hexaluminate crystal structure, as noted above.

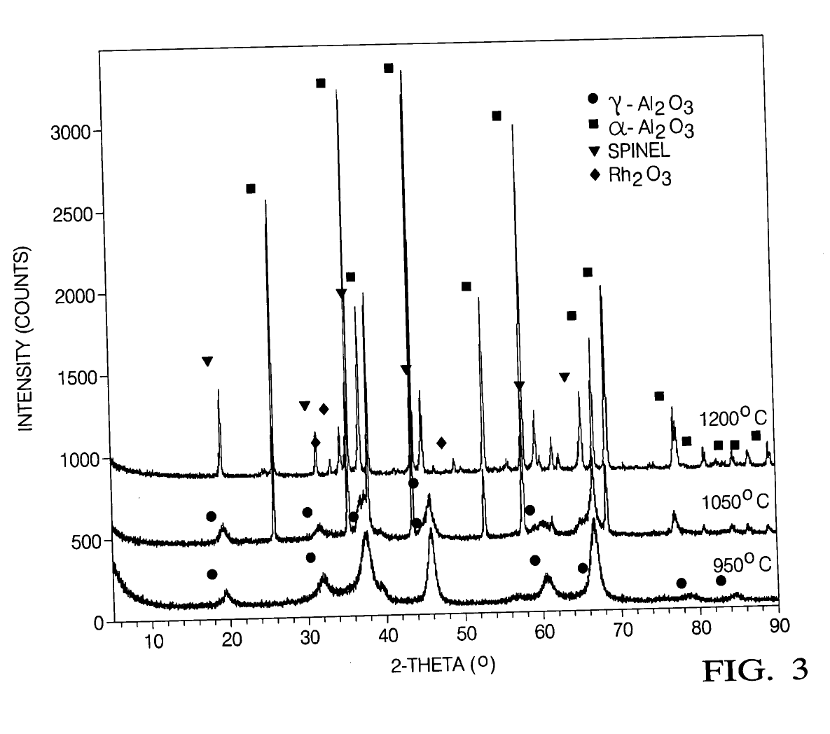

As shown in FIG. 3, no spinel phase was detected in the Rh/MgO—Al₂O₃ by XRD after heat treatment at about 950° C. After heat treatment at about 1,050° C., an alpha-alumina phase was detected, and the catalyst support remained free of a spinel phase. After heat treatment at about 1,200° C., an alpha-alumina phase, significant amounts of spinel, and small amounts of rhodium oxide were detected.

Comparing FIGS. 2 and 3 with the catalytic performance of the compositions reported in FIGS. 1A and 1B shows that a composition containing LaMgAl₁₁O₁₉ (such as in FIG. 2) had superior performance, even when containing small amounts of spinel, as compared to a composition containing significant amounts of MgAl₂O₄ spinel (such as in FIG. 3). Thus, a stabilized alumina catalyst support comprising a hexaluminate (in this instance, LaMgAl₁₁O₁₉) provided superior catalytic performance in comparison to a catalyst support including a spinel-stabilized alumina, but without a hexaluminate.

### Example 4

Addition of a second metal oxide to the catalyst support. Table 2 shows the reformate gas composition over differently modified catalyst supports. All finished catalysts were heat treated for about 10 hours at about 1,200° C. prior to testing. The test method of Example 1 was used. In the present example, a second metal oxide was added to an alumina material that was previously modified with about 3 wt. % La₂O₃ (using method A2 in Table 1), and Rh was added by addition of aqueous solution of Rh nitrate, also as described in Table 1 for method A2. The catalyst and support were washcoated on 20 PPI ZTA substrates.

TABLE 2

| | Trivalent cation | Divalent cation | | |
|---|---|---|---|---|
| | component | component | H₂ (vol. %) | % max. H₂ |
| 4A | 3 wt. % La₂O₃ | — | 20.3 | 85 |
| 4B | 3 wt. % La₂O₃ | MgO | 22.1 | 92 |
| 4C | 3 wt. % La₂O₃ | CaO | 19.5 | 81 |
| 4D | 3 wt. % La₂O₃ | BaO | 18.4 | 77 |
| 4E | 7 wt. % La₂O₃ | — | 20.7 | 86 |
| 4F | 3 wt. % La₂O₃ | NiO | 22.0 | 92 |
| 4G | 3 wt. % La₂O₃ | CoO | 21.2 | 88 |
| 4H | 3 wt. % La₂O₃ | ZnO | 21.3 | 89 |
| 4I | 3 wt. % La₂O₃ | FeO | 21.5 | 90 |

As shown in Table 2, the addition of a second component significantly affected the catalyst performance. The addition of MgO, NiO, CoO, ZnO, or FeO (samples 4B, 4F, 4G, 4H and 4I) enhanced the catalyst stability and hydrogen selectivity, whereas the addition of CaO and BaO (samples 4C and 4D) decreased the catalyst stability, as shown by the relatively low hydrogen selectivity. In addition, increasing the concentration of La₂O₃ (sample 4E) also enhanced the catalyst stability and hydrogen selectivity. The best hydrogen selectivity was observed with La₂O₃ as the first component and MgO or NiO as the second component (samples 4B and 4F). Not to be limited by theory, it is thought that the addition of a divalent cation (e.g., Mg, Ca, Ba, Ni, Co, Zn and/or Fe) and a trivalent cation (e.g., La) to a mixture with a stoichiometric excess of alumina results in a surprisingly thermally stable catalyst support material, comprising a hexaluminate (e.g., LaMgAl₁₁O₁₉, LaCaAl₁₁O₁₉, LaBaAl₁₁O₁₉, LaNiAl₁₁O₁₉, LaCoAl₁₁O₁₉, LaZnAl₁₁O₁₉, LaFeAl₁₁O₁₉), which performs well with rhodium-based catalysts. Not to be bound by any theory, it is hypothesized that the less favorable performance of the compositions containing Ca and Ba may have been the result of the formation of binary oxide compounds (e.g., BaAl₂O₄, Ba₂Al₂O₅, BaAl₄O₇, CaAl₂O₄, Ca₂Al₂O₅, CaAl₄O₇, etc., and/or the like), which were formed at the expense of the ternary hexaluminate compounds.

### Example 5

Three different supported catalysts were made using method A2 from Example 1. Three different alumina crystal phases were used as the starting material, as shown below in Table 3, and Rh was used as the catalyst in each. The supported catalysts were treated for about ten (10) hours at about 1,200° C. prior to testing. Rh addition, substrate, and test methods were the same as in Example 4.

As shown below in Table 3, the use of γ-alumina for the catalyst support showed the best hydrogen selectivity, whereas the use of α-alumina resulted in the lowest hydrogen selectivity. Thus, γ-alumina showed the best performance.

TABLE 3

| | Alumina support | H₂ (vol. %) | % max. H₂ |
|---|---|---|---|
| 3A | gamma alumina | 22.1 | 92 |
| 3B | theta alumina | 21.6 | 90 |
| 3C | alpha alumina | 19.0 | 79 |

### Example 6

Comparison of Rh loading and/or MgO, loading of the supported catalyst. Catalysts were made using method A2 in Table 1. All catalysts were treated for about ten (10) hours at about 1,200° C. prior to testing. Rh addition, test methods, and substrate were the same as described in Example 4.

As shown in Table 4, the best performance (highest hydrogen selectivity and lowest methane concentration) was achieved with a MgO loading of about 5 wt. % when the Rh loading was kept constant at about 5 wt. %, whereas the performance did not appear to be affected when the MgO content was maintained at about 5 wt. % while the Rh loading was increased from about 5 wt. % to about 10 wt. %.

TABLE 4

| | Catalyst | Catalyst support | | |
|---|---|---|---|---|
| | loading | loading | | |
| | (wt. % Rh) | (wt. % MgO) | H₂ (vol. %) | % max. H₂ |
| 4A | 5 | 3 | 21.7 | 90 |
| 4B | 5 | 5 | 22.1 | 92 |
| 4C | 5 | 10 | 21.3 | 89 |
| 4D | 10 | 5 | 22.0 | 92 |

### Example 7

Comparison of catalyst composition. Several catalyst compositions were formed. The catalyst composition and catalyst support composition are shown below in Table 5. All supported catalysts were made using method A2 in Table 1. All catalysts were treated at for about 10 hours at about 1,200° C. prior to testing. Rh addition, test procedure, and substrate were the same as Example 4.

TABLE 5

| | | | AFTER | | AFTER 1,300° C. | |
|---|---|---|---|---|---|---|
| | | Catalyst | NORMAL RUN | | TREATMENT | |
| | | Support | % max. | H₂ | % max. | H₂ |
| | Catalyst Composition | Composition | H₂ | (vol. %) | H₂ | (vol. %) |
| 5A | 5 wt. % Rh | La—Mg—Al—O | 92 | 22.1 | 90 | 21.5 |
| 5B | 3% wt. % Rh/2 wt. % Pt | La—Mg—Al—O | 91 | 21.8 | 89 | 21.3 |
| 5C | 3 wt. % Rh/2 wt. % Pd | La—Mg—Al—O | 91 | 21.8 | 87 | 21.0 |
| 5D | 3 wt. % Rh/2 wt. % Ni | La—Mg—Al—O | 93 | 22.2 | 92 | 22.1 |
| 5E | 3 wt. % Rh/2 wt. % Ni | La₂O₃ | 87 | 20.8 | <87 | — |
| | | stabilized | | | | |
| | | alumina | | | | |

As shown in Table 5, the addition of Ni to Rh improved the catalyst stability, especially after the 1,300° C. heat treatment. In comparison to Rh only, the hydrogen concentration decreased slightly for Rh—Pt and Rh—Pd catalysts, but remained approximately the same for the Rh—Ni catalyst. The relative hydrogen concentration of the Rh—Ni supported on the La—Mg—Al—O was about 22.2% (which was maintained after the 1,300° C. heat treatment), whereas the Rh—Ni supported on La₂O₃ stabilized alumina, was 20.8%. Thus, the combination of La—Mg—Al—O was an excellent Rh catalyst support for high temperature partial oxidation reactions.

### Example 8

Comparison of catalyst compositions. Four catalyst supports were formed using methods 1A and 1B of Example 1, based on the formulations shown below in Table 6. After addition of 5 wt. % Rh to each composition, the materials were further treated in air at 1200° C. for 10 hours. The composition of the fired supported catalysts was determined by XRD, also as shown below in Table 6. Each composition was evaluated for conversion of fuel in a similar to the manner described in Example 1, (after 170 minutes of testing to allow for stabilization of performance). The fuel and airflow rates were selected to provide a space velocity of about 63,100/hour, calculated at 0° C. and at a pressure of 1 atmosphere, and considering all fuel molecules to be in the gas phase. A fuel flow rate of 2.99 g/minute was required to reach this space velocity. The fuel was a diesel fuel containing 50 parts per million, by weight, sulfur; 30.4 volume percent aromatic compounds; and 13.7 wt. % hydrogen. The test results are shown below in Table 6.

TABLE 6

| | Composition of | | | Composition of | | | | |
|---|---|---|---|---|---|---|---|---|
| | Catalyst Support | | | Catalyst Support | | | | |
| | Formulation* | | | [Post Firing] | | Hydrogen Production | | |
| | MgO | La₂O₃ | Ce₂O₃ | | Al₂O₃ | H₂ | % max. | % H₂ rate of |
| | (wt. %) | (wt. %) | (wt. %) | Hexaluminate | phase | (vol. %) | H₂ | change (%/min) |
| 8A | 5 | 4 | 0 | LaMgAl₁₁O₁₉ | delta | 21.0 | 100 | −0.001 |
| 8B | 5 | 10 | 0 | LaMgAl₁₁O₁₉ | theta | 20.3 | 98 | −0.001 |
| 8C | 5 | 20 | 0 | LaMgAl₁₁O₁₉ | — | 19.7 | 94 | −0.005 |
| 8D | 5 | 4 | 0.5 | — | — | 20.4 | 98 | 0.000 |

*the composition is prior to firing, with the balance of the composition being Al₂O₃

Composition 8A had the highest hydrogen concentration in the product gas, and composition 8C had the lowest hydrogen concentration. Compositions 8A, 8B and 8D produced concentrations of greater than 20 vol. % hydrogen in the product gas, and were therefore considered acceptable for use in solid-oxide fuel cells, whereas composition 8C produced a concentration of less than 20 vol. % hydrogen, which was below the level considered acceptable for use in a solid-oxide fuel cell. (i.e., less than 20 vol. % hydrogen). Compositions 8A, 8B, and 8D, each of which contained hexaluminate (LaMgAl₁₁O₁₉) and alumina, produced catalysts having both superior performance and stability, as evidenced by the low rate of change of hydrogen production. Composition 8C, which was substantially free of alumina (i.e. comprising only hexaluminate (LaMgAl₁₁O₁₉)), did not exhibit either the favorable ability to produce greater than or equal to about 20 vol. % hydrogen, and did not have good stability.

The present catalysts can comprise several improved characteristics such as: thermal stability at temperatures of about 1,300° C. or more, which can allow them to withstand transient temperature increases in exhaust or fuel reforming operations; are effective for partial oxidation reactions; maintain hydrogen production at levels of greater than 20 vol. % at temperatures of about 1,300° C. or more; and the ability to use existing processes and equipment for formation.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A fuel reforming catalyst, comprising:
a catalyst support comprising a hexaluminate and alumina, wherein the catalyst support was formed from a mixture comprising a greater than stoichiometric concentration of alumina and a material selected from the group consisting of a divalent cation component, a trivalent cation component, and combinations comprising at least one of the foregoing; and
a rhodium catalyst disposed at the catalyst support.

2. The fuel reforming catalyst of claim 1, wherein the catalyst is capable of producing greater than or equal to about 20 vol. % hydrogen after treatment at a temperature of greater than or equal to about 1,200° C.

3. The fuel reforming catalyst of claim 1, wherein the catalyst is capable of producing greater than or equal to about 20 vol. % hydrogen after treatment at a temperature of greater than or equal to about 1,300° C.

4. The fuel reforming catalyst of claim 1, wherein the catalyst is capable of producing greater than or equal to about 20 vol. % hydrogen after treatment at a temperature of greater than or equal to about 1,370° C.

5. The fuel reforming catalyst of claim 1, wherein the hexaluminate is selected from the group consisting of M₁₃O₁₉, M₁₆O₂₂, M₁₆O₂₃, M₁₉O₂₇, and combinations comprising at least one of the foregoing.

6. The fuel reforming catalyst of claim 1, wherein the hexaluminate comprises the formula LaMAl₁₁O₁₉, and wherein M is selected from the group consisting of Ba, Ca, Cr, Co, Fe, Mg, Mn, Ni, Sr, Zn, and combinations comprising at least one of the foregoing.

7. The fuel reforming catalyst of claim 1, wherein the hexaluminate comprises LaMgAl₁₁O₁₉.

8. A method of making an fuel reforming catalyst, comprising:
forming a mixture of a divalent cation component, a trivalent cation component, and a greater than stoichiometric concentration of alumina;
heating the mixture to a temperature of greater than or equal to about 1,200° C. to form a catalyst support comprising a hexaluminate; and
disposing a rhodium catalyst at the catalyst support.

9. The method of claim 8, wherein the mixture comprises about 1.0 wt. % to about 10 wt. % of the divalent cation component, and about 4.0 wt. % to about 12.0 wt. % of the trivalent cation component, based on the total weight of the mixture.

10. The method of claim 8, wherein disposing the rhodium catalyst comprises adding the rhodium catalyst to the mixture.

11. The method of claim 8, wherein the mixture comprises alumina selected from the group consisting of delta phase alumina, theta phase alumina, gamma phase alumina, and combinations comprising at least one of the foregoing.

12. The method of claim 11, wherein the alumina is gamma phase alumina.

13. The method of claim 8, wherein the alumina comprises a surface area of about 20 m²/g to about 50 m²/g.

14. The method of claim 8, wherein the catalyst is capable of producing greater than or equal to about 20 vol. % hydrogen after treatment at a temperature of greater than or equal to about 1,200° C.

15. The method of claim 8, wherein the catalyst is capable of producing greater than or equal to about 20 vol. % hydrogen after treatment at a temperature of greater than or equal to about 1,300° C.

16. The method of claim 8, wherein the catalyst is capable of producing greater than or equal to about 20 vol. % hydrogen after treatment at a temperature of greater than or equal to about 1,370° C.

17. A fuel reforming catalyst, comprising:
a catalyst support comprising a hexaluminate and alumina, wherein the catalyst support was formed from a mixture comprising a greater than stoichiometric concentration of alumina, and wherein the hexaluminate comprises the formula LaMAl₁₁O₁₉, where M is selected from the group consisting of Ba, Ca, Cr, Co, Fe, Mg, Mn, Ni, Sr, Zn, and combinations comprising at least one of the foregoing; and
a rhodium catalyst disposed at the catalyst support;
wherein the catalyst is capable of producing greater than or equal to about 20 vol. % hydrogen after treatment at a temperature of greater than or equal to about 1,200° C.

18. The fuel reforming catalyst of claim 17, wherein the hexaluminate comprises LaMgAl₁₁O₁₉.
